(19) United States
(12) Patent Application Publication
(10) Pub. No.: US 2011/0126420 A1
(43) Pub. Date: Jun. 2, 2011

(54) Footwear support

(76) Inventors: Luc Blais, Laval (CA); Diane Blais, Ste-Marthe-sur-le-Lac (CA)

(21) Appl. No.: 12/591,690

(22) Filed: Nov. 30, 2009

(51) Int. Cl. A01F 25/12

(52) U.S. Cl. 34/239

(57) ABSTRACT

A footwear support for supporting a footwear article onto a support surface. The footwear support includes a base positionable onto the support surface. The footwear support also includes a supporting element extending substantially away from the base for supporting the footwear article. The supporting element defines a supporting element first end and a substantially opposed supporting element second end. The supporting element first end is located substantially adjacent to the base. The supporting element is configurable between a shorter configuration and a longer configuration. The supporting element second end is further away from the base in the longer configuration than in the shorter configuration.

### FIELD OF THE INVENTION

The present invention relates to the general field of footwear, and is particularly concerned with a footwear support.

### BACKGROUND OF THE INVENTION

There are many situations in which a footwear article, for example a boot or a shoe, may become wet. In these cases, it is often desirable that the footwear article be dried as fast as possible for re-use thereafter. For example, if a shoe becomes wet after having been used in the rain or snow, an intended user of the shoe may wish to wear the shoe again only a few hours afterwards, for example when leaving a home in the morning after coming home at night with wet shoes.

Implements usable for facilitating the drying of footwear articles are not very popular and difficult to find commercially. Consequently, most people typically only leave their shoes or boots to dry in ambient air or, sometimes, position these footwear articles close to a heat source such as, for example a baseboard heater.

However, typically, the footwear article is positioned with the opening thereof facing upwardly. In other words, the footwear article is positioned in the orientation in which it is typically used by intended users. Unfortunately, this creates a tendency to trap humidity inside the footwear article. In turn, this slows down the drying of the footwear article.

Against this background, there exists a need in the industry to provide an improved apparatus for facilitating water evaporation from footwear. An object of the present invention is therefore to provide such an apparatus in the form of a footwear support.

### SUMMARY OF THE INVENTION

In a broad aspect, the invention provides a footwear support for supporting a footwear article onto a support surface. The footwear support includes a base positionable onto the support surface. The footwear support also includes a supporting element extending substantially away from the base for supporting the footwear article. The supporting element defines a supporting element first end and a substantially opposed supporting element second end. The supporting element first end is located substantially adjacent to the base. The supporting element is configurable between a shorter configuration and a longer configuration. The supporting element second end is further away from the base in the longer configuration than in the shorter configuration.

Advantageously, the proposed footwear support allows for the insertion of the footwear article onto the supporting element in an orientation in which an opening of the footwear article faces downwardly. This facilitates evacuation of the humidity from the footwear article.

In addition, the proposed footwear support includes a supporting element defining configurations having different lengths, in other words, extending over different distances away from the base. This improves stability of the footwear support as footwear having relatively small dimensions can be positioned on the supporting element when the supporting element is in the shorter configuration, while footwear having longer dimensions such as, for example, knee-high boots, are positionable onto the footwear support with the supporting element in the longer configuration. Therefore, the center of gravity of each type of footwear article is relatively low if a suitable configuration is used for the supporting element.

In some embodiments of the invention, the footwear support is relatively easily manufacturable at relatively low costs and is usable without specialized tools. For example, passing between the shorter and longer configurations is made using a relatively small number of quick and ergonomic steps.

In some embodiments of the invention, the footwear support is made out of metal wires and the supporting element includes at least 3 segments defining threaded sections allowing to removably attach the segments to each other. An advantage of having a footwear support having this configuration is that the supporting elements are then detachable from the base for facilitating storage of the footwear support.

Other objects, advantages and features of the present invention will become more apparent upon reading of the following non-restrictive description of preferred embodiments thereof, given by way of example only with reference to the accompanying drawings.

### BRIEF DESCRIPTION OF THE DRAWINGS

In the appended drawings:

FIG. 1, in a perspective view, illustrates a footwear support for supporting a footwear article in accordance with an embodiment of the present invention, the footwear article being shown in phantom lines, the footwear support including a supporting element, the supporting element being shown in a longer configuration;

FIG. 2, in a perspective exploded view, illustrates the footwear support shown in FIG. 1;

FIG. 3, in a side cross-sectional view, illustrates a female threaded section of a segment included in the supporting element of the footwear support shown in FIGS. 1 and 2; and

FIG. 4, in a perspective view, illustrates the footwear support shown in FIGS. 1 and 2, the footwear support being shown with the supporting elements thereof in a shorter configuration.

### DETAILED DESCRIPTION

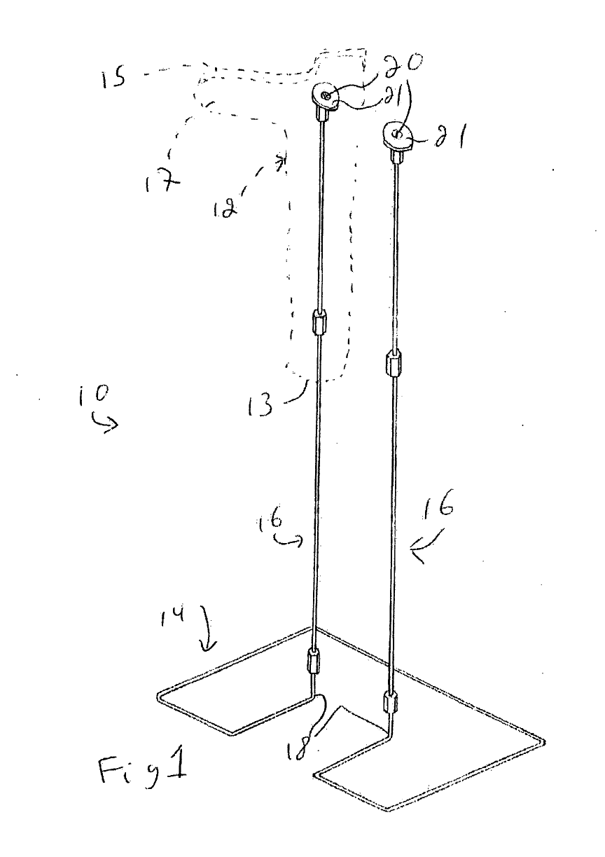

Referring to FIG. 1, there is shown a footwear support 10 for supporting a footwear article 12 onto a support surface (not shown in the drawings). For example, the footwear article 12 is a boot, a shoe, or any other type of footwear article. The footwear article 12 includes a sole 15 and an upper 17 extending from the sole 15. The upper 17 defines a conventional opening 13 allowing an intended user thereof to insert a foot (not shown in the drawings) thereinto for wearing the footwear article 12.

The footwear support 10 includes a base 14 positionable onto a support surface (not shown in the drawings) and at least one, and typically two, supporting elements 16 extending substantially away from the base 14 for supporting the footwear article 12. Each supporting element 16 defines a supporting element first end 18 and a substantially opposed supporting element second end 20. The supporting element first end 18 is located substantially adjacent to the base 14, while the supporting element second end 20 is located in a substantially spaced apart relationship relatively to the base 14.

Each supporting element 16 is configurable between a shorter configuration, shown in FIG. 4, and a longer configuration, shown in FIG. 1. The supporting element second end 20 is further away from the base 14 in the longer configuration than in the shorter configuration.

In some embodiments of the invention, the supporting element 16 includes a footwear abutment 21 located substantially adjacent the supporting element second end 20. For example, the footwear abutment 21 takes the form of a substantially disc-shaped plastic element allowing to position the footwear article 12 thereonto, for example by abutting the sole 15 thereonto.

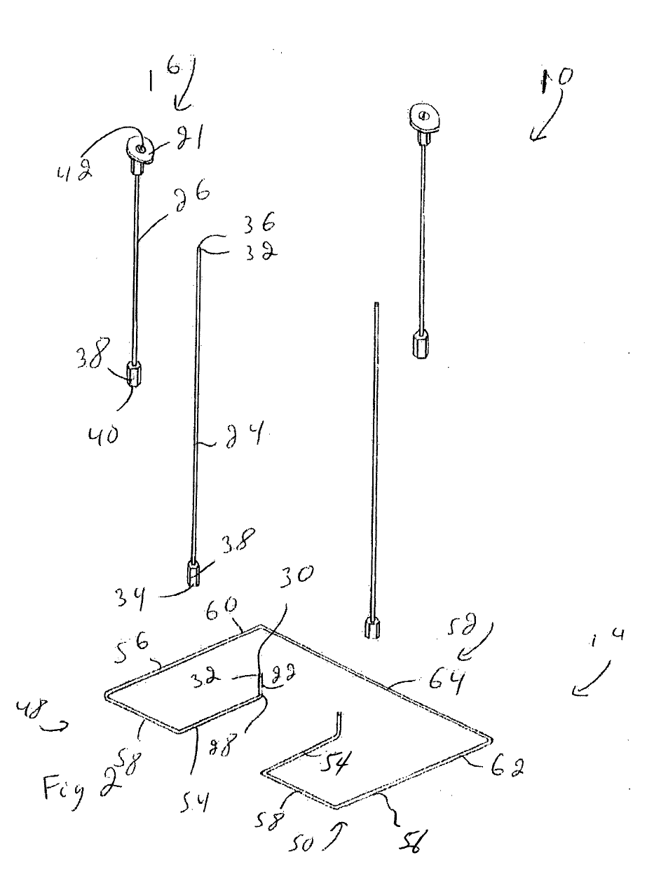

Referring to FIG. 2, each supporting element 16 includes first, second and third segments 22, 24 and 26. Typically, the first segment 22 extends integrally from the base 14. The second segment 24 is removably attachable to the first segment 22 and the third segment 26 is removably attachable alternatively to either the second segment 24 or to the first segment 22. In these embodiments, the longer configuration is achieved by attaching the second segment both to the first segment 22 and to the third segment 26 with the second segment 24 positioned between the first and third segments 22 and 26. To achieve the shorter configuration, the second segment 24 is omitted from this assembly and the third segment 26 is attached directly to the first segment 22. However, in alternative embodiments of the invention, the longer and shorter configurations are achieved in any other suitable manner.

The first segment 22 defines a first segment first end 28 located substantially adjacent to the base 14 and a substantially opposed first segment second end 30 located in a spaced apart relationship relatively to the base 14. Typically, a male threaded section 32 is provided substantially adjacent the first segment second end 30.

The second segment 24 defines a second segment first end 34 and a substantially opposed second segment second end 36. A male threaded section 32 is provided substantially adjacent the second segment second end 36 and a female threaded section 38 is provided substantially adjacent the second segment first end 34. The female threaded section 38 of the second segment 24 is screwable onto the male threaded section 32 of the first segment 22.

The third segment 26 defines a third segment first end 40 and a substantially opposed third segment second end 42. The footwear abutment 21 is typically provided substantially adjacent the third segment second end 42, while a female threaded section 38 is provided substantially adjacent the third segment first end 40. The female threaded section 38 of the third segment 26 is threadable alternatively onto the male threaded section 32 of the first segment 22 and the male threaded section 32 of the second segment 24.

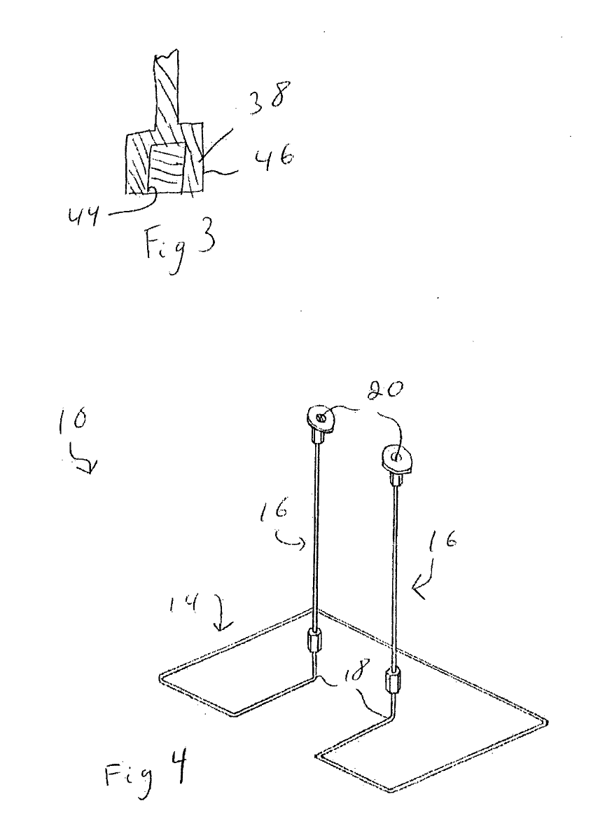

Referring to FIG. 3, there is shown in more details the female threaded section 38. The female threaded section 38 defines a threaded bore 44 extending substantially longitudinally thereinto for receiving a male threaded section 32 thereinto. In addition, the female threaded section 38 defines a female threaded section outer surface 46 which is typically shaped for facilitating screwing and unscrewing the female threaded section 38 to and from a male threaded section 32. For example, this is achieved by adding a female threaded section outer surface 46 that has a substantially hexagonal cross-sectional configuration in a plane perpendicular to a longitudinal axis of the threaded bore 44. However, in alternative embodiments of the invention (not shown in the drawings), this is achieved by including ridges, protrusions, bumps, non-slippery materials such as silicone, or any other features onto the outer surface of the female threaded section 38.

An advantage of having a female threaded section outer surface 46 having a substantially hexagonal configuration is to facilitate the use of a wrench to remove either of the second and third segments 24 and 26 from a male threaded section 32 in cases in which corrosion partially binds either the second and third segments 24 and 26 to one of the first and second segments 22 and 24.

In some embodiments of the invention, the female threaded section 38 has a threaded bore 44 that open generally downwardly when attached to a male threaded section 32. This prevents water from easily entering the threaded bore 44 and, therefore, reduces the risks of corrosion that may damage the supporting element 16.

Referring to FIG. 2, typically, the base 14 defines a sustentation polygon (not shown explicitly in the drawings) and is configured such that the supporting element 16 extends substantially vertically from the base 14 at a location located substantially centrally located relatively to the sustention polygon.

For example, this is achieved by having a base 14 including a base first leg 48, a base second leg 50 extending substantially parallel in a spaced apart relationship relatively to the base first leg 48 and a base leg connector 52 for mechanically coupling to each other the base first and second legs 48 and 50. Therefore, in these configurations, the base 14 is generally U-shaped.

In some embodiments of the invention, the base 14 is made out of metal wires and, in these embodiments, the base first and second legs 48 and 50 are also each substantially U-shaped and the base leg connector 52 is also substantially U-shaped.

In these embodiments each of the base first and second legs 48 and 50 include a leg first segment 54, a leg second segment 56 extending substantially parallel to the leg first segment 54 and a leg third segment 58 extending between the leg first and second segments 54 and 56 substantially adjacent a respective end thereof. The base leg connector 52 includes a connector first segment 60, a connector second segment 62 extending substantially parallel to the connector first segment 60 and a connector third segment 64 extending between the connector first and second segment 60 and 62.

The connector first and second segments 60 and 62 each extend from a respective one of the leg second segments 56 substantially opposed to the leg third segments 58. The connector third segment 64 extends substantially opposed to the leg third segments 58 and is substantially parallel thereto. Also, the first segments 22 of the supporting elements 16 each extend from a respective one of the leg first segments 54 substantially opposed to the leg third segments 58.

In some embodiments of the invention, the base 14 and the first segments 22 that extend substantially integrally therefrom are formed by bending a metal wire to achieve the configuration described hereinabove.

In use, the second and third segments 24 and 26, or only the third segment 26, are attached to the first segment 22 to achieve respectively either the longer or the shorter configurations. Then, the footwear article 12 is inserted through the opening 13 upside down onto the supporting element 16 to allow drying of the footwear article 12. After use, the footwear article 12 may be removed from the footwear support 10 and the second and third segments 24 and 26 may be unscrewed from each other and from the first segment 22 to facilitate storage of the footwear support 10.

Although the present invention has been described hereinabove by way of preferred embodiments thereof, it can be modified, without departing from the spirit and nature of the subject invention as defined in the appended claims.

What is claimed is:

1. A footwear support for supporting a footwear article onto a support surface, said footwear support comprising:
a base positionable onto said support surface; and
a supporting element extending substantially away from said base for supporting said footwear article, said supporting element defining a supporting element first end and a substantially opposed supporting element second end, said supporting element first end being located substantially adjacent to said base;
said supporting element being configurable between a shorter configuration and a longer configuration, said supporting element second end being further away from said base in said longer configuration than in said shorter configuration.

2. A footwear support as defined in claim 1, wherein said supporting element includes a supporting element first segment extending from said base and a supporting element second segment extending from said supporting element first segment, said supporting element first and second segments being removably attachable to each other.

3. A footwear support as defined in claim 2, wherein said supporting element first segment is removably attachable to said base.

4. A footwear support as defined in claim 1, wherein said supporting element defining a footwear abutment substantially adjacent to said supporting element first end.

5. A footwear support as defined in claim 1, wherein said base is made out of bent metal wire.
